(19) United States
(12) Patent Application Publication
(10) Pub. No.: US 2026/0336595 A1
(43) Pub. Date: Oct. 29, 2026

(54) Method to Compensate in the Event of a Fault or Failure of an Evaluation Device of a Parking Brake System

(71) Applicant: Robert Bosch GmbH, Stuttgart (DE)

(72) Inventors: Matthias Vieth, Besigheim (DE); Jonathan Linse, Lonsee (DE); Torsten Manthey, Obersulm (DE)

(21) Appl. No.: 19/654,856

(22) Filed: Apr. 22, 2026

(30) Foreign Application Priority Data
Apr. 24, 2025 (DE) 102025115789.8

(51) Int. Cl. B60T 17/22; B60T 8/174

(52) U.S. Cl. CPC B60T 17/221; B60T 8/174; B60T 2270/406; B60T 2270/413

(57) ABSTRACT

A method to compensate for a fault or failure of an evaluation device of a parking brake system is disclosed. The parking brake system includes a parking brake control unit. The evaluation device performs a parking brake function during normal operation by way of the parking brake control unit. During the normal operation, the parking brake function is learned by way of machine learning, and this learned function is used in the event of a fault or failure of the evaluation device to perform a replacement parking brake function.

This application claims priority under 35 U.S.C. § 119 to patent application no. DE 10 2025 115 789.8, filed on Apr. 24, 2025 in Germany, the disclosure of which is incorporated herein by reference in its entirety.

The present disclosure relates to a method to compensate in the event of a fault or failure of an evaluation device of a parking brake system. The disclosure further relates to a computer program product for carrying out the method as well as a parking brake system.

### BACKGROUND

A parking brake system is used to perform parking brake functions, such as engaging or releasing a parking brake. To this end, the parking brake system typically includes an evaluation device and a parking brake control unit. The evaluation device is capable of performing a parking brake function via the parking brake control unit. In normal operation, i.e., if there is no fault in the evaluation device, parking brake functions are performed by the evaluation device by way of the parking brake control unit.

The respective parking brake function is usually dependent on parameters, which are available to the evaluation device as input parameters.

In the event of a fault or failure of the evaluation device, a parking brake function can, in principle, be rigidly specified as a substitute. However, this may result in damage to the parking brake system and/or a reduction in the reliability of the parking brake function.

It is therefore the object of the present disclosure to specify a method, a computer program product and a parking brake system, by way of which the aforementioned drawbacks are eliminated or at least reduced.

This object is achieved by the features set forth below. Advantageous variants are also set forth below.

### SUMMARY

Accordingly, the core idea of the disclosure is to learn, and preferably optimize, a parking brake function performed by a parking brake control unit of the parking brake system by way of machine learning in a fault-free operation of a parking brake system, hereinafter referred to as “normal operation,” and to implement the learned function in the event of a fault, that is, in particular, in the event of a fault or failure of an evaluation device of the parking brake system, in order to perform the parking brake function. Compared to the previous practice of accessing specified, fixed parking brake functions in the event of a fault, the idea according to the disclosure results in needs-based and adapted execution of the parking brake function in the event of a fault. In this way, both reliability in the event of a failure is increased and wear, in particular of parking brakes, is reduced.

The core idea is advantageously implemented in a method to compensate in the event of a fault or failure of the evaluation device of the parking brake system. The parking brake system also comprises a parking brake control unit for performing a parking brake function. The evaluation device receives input parameters during normal operation and, as a function of the input parameters, performs a parking brake function by way of the parking brake control unit. During the normal operation, the parking brake function performed by the evaluation device is learned by way of machine learning. The function thus learned is also hereinafter referred to as such, i.e. as a “learned function.” In the event of a fault, that is, in the event of a fault or failure of the evaluation device, a corresponding parking brake function is performed to compensate by way of the learned function as a function of at least a part of the input parameters, which is also subsequently referred to as a “replacement parking brake function.”

Learning the learned function also includes training the learned function in the context of the present disclosure.

The evaluation device can, in principle, be configured as desired.

The evaluation device can comprise a microcontroller, for example. The evaluation device can in particular be configured as a microcontroller.

Preferably, in an original state, that is, prior to learning by way of machine learning during normal operation, a function is stored in advance in the parking brake system and/or in the associated vehicle, which is adapted to the vehicle and/or to the at least one parking brake. In the course of machine learning, this previously stored function is improved and/or optimized so that said learning occurs.

The respective parking brake control unit serves to control at least one parking brake in an associated vehicle. For this purpose, the parking brake control unit may comprise at least one application-specific integrated circuit, also referred to hereinafter as “ASIC”, wherein ASIC stands for “Application-Specific Integrated Circuit”.

The parking brake control unit may comprise an associated ASIC for at least one parking brake of the associated parking brake system. It is particularly conceivable that the parking brake control unit for two parking brakes comprises such an ASIC for each parking brake, i.e., two ASICs.

The dependence of the parking brake function on the input parameters means that there is a respectively adapted parking brake function for different input parameters. These are also hereinafter referred to as being associated with one another. That is, a parking brake function may be associated with a set of input parameters.

The parking brake function may be of any type, provided it controls at least one parking brake.

In particular, the parking brake function is a function for automatic control of the parking brake, in particular a function of an automatic parking brake.

For example, the parking brake function is a function for engaging the parking brake.

Also, the parking brake function may be a function for deactivating, that is, disengaging, the parking brake.

The core idea is advantageously implemented in a computer program product for carrying out the method. The computer program product comprises instructions that, when executed by a computer, cause the computer to carry out the method.

The computer may be a component of the parking brake system and/or the associated vehicle.

The computer program product is suitably stored on a non-volatile memory, for example in the parking brake system and/or in the associated vehicle.

The core idea is advantageously implemented in a corresponding parking brake system. The parking brake system comprises such a parking brake control unit and such an evaluation device, which, during normal operation, perform the parking brake function. In addition, the parking brake system comprises a control device configured to perform the method to compensate for a fault or failure of the evaluation device.

The control device may at least partially comprise the computer.

The computer program product may be stored at least partially in the control device.

The learning of the parking brake function may be implemented in hardware on any of the components.

It is particularly conceivable to learn the learned function on a device external to the parking brake system and/or the associated vehicle, for example in a cloud.

It is conceivable to learn the learned function at least in part by way of the evaluation device. That is, the machine learning is performed at least in part by way of the evaluation device.

Alternatively or additionally, it is conceivable to learn the learned function at least in part by way of at least one of the at least one ASIC. That is, machine learning is performed at least in part by way of at least one of the at least one ASIC.

The learned function is preferably stored in the parking brake control unit, in particular in at least one of the at least one ASIC, preferably in the respective ASIC. The learned function can thus be used, in the event of a fault or failure of the evaluation device, to perform the replacement parking brake function.

The storing of the learned function in the parking brake control unit takes place in particular by transferring the learned function to the parking brake control unit, in particular to at least one of the at least one ASIC.

The storing of the learned function is preferably carried out repeatedly, in particular after improvements are made to the learned function.

The input parameters may, in principle, be of any type.

Expediently, the particular input parameter has a relevance to the parking braking function, particularly for a braking force, with which the parking braking function is performed, and/or a relevance to the duration, for which the parking brake is controlled.

For example, the input parameters may comprise: an electrical current, an electrical voltage, a temperature of at least one associated parking brake, a slope, on which the associated vehicle is located, and the like.

In preferred embodiments, at least a part of the input parameters and the respective associated parking braking function are considered for learning the learned function. This occurs in such a way that the respective executed parking brake function is made dependent on the associated, considered input parameters. Thus, there is reliable and simplified learning of the learned function by way of machine learning.

It is particularly expedient if, in the event of a fault or failure of the evaluation device, the replacement parking brake function is performed as function of the at least one considered input parameter.

Preferably, the considered input parameters are recorded, and the respective associated parking brake function is evaluated, such that the respective parking brake function is dependent on the associated, considered input parameters. Thus, it is particularly possible to have a time profile of the input parameters available in order to achieve improved learning of the learned function by way of machine learning.

Simplified learning of the learned function is achieved through the respective parking brake function performed being made dependent on the associated, considered input parameters by way of regression, in particular by way of at least one linear regression.

For example, the learned parking brake function may be a release duration for releasing at least one parking brake. That is, as a replacement parking brake function, a release duration for releasing the at least one parking brake is learned as a function of, in particular, the considered input parameters.

The use of the learned function as well as the execution of the replacement parking brake function may be performed by any of the components of the parking brake system. In particular, the parking brake system may comprise a further evaluation unit for this purpose.

Further important features and advantages of the disclosure will emerge from the drawings and from the associated description of the figures with reference to the drawings.

It goes without saying that the aforementioned features and the features yet to be explained in the following can be used not only in the respectively specified combination, but also in other combinations or on their own, without leaving the scope of the present disclosure.

Preferred exemplary embodiments of the disclosure are shown in the drawings and will be explained in more detail in the following description, wherein same reference numerals refer to same or similar or functionally same components.

### BRIEF DESCRIPTION OF THE DRAWINGS

The figures schematically show the following:

The figures schematically show the following:

FIG. 1 a highly simplified schematic illustration of a parking brake system,

FIG. 2 a flow chart illustrating normal operation of the parking brake system,

FIG. 3 a flow chart illustrating an operation of the parking brake system in the event of a fault or failure.

### DETAILED DESCRIPTION

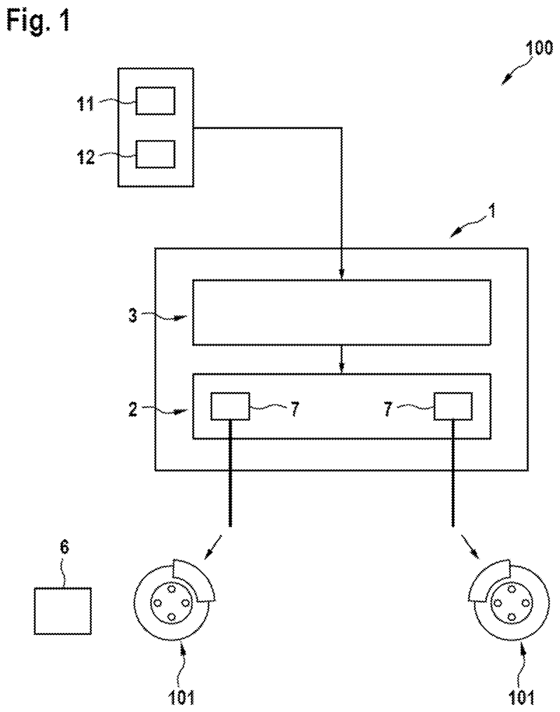

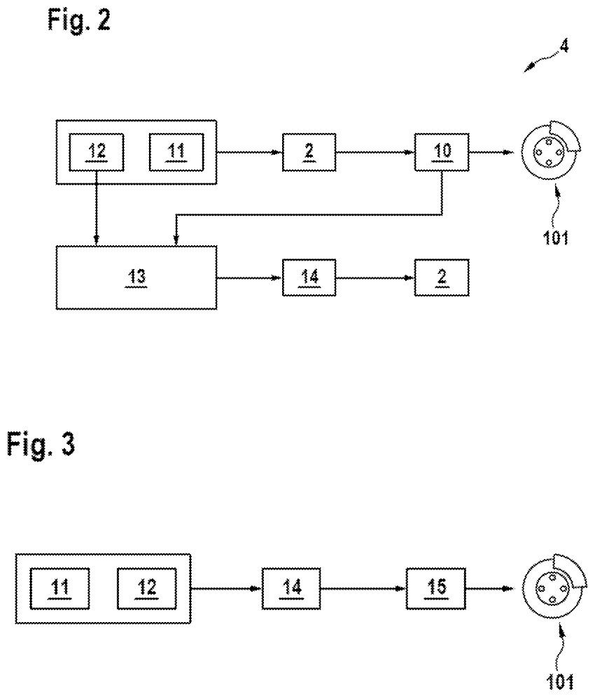

An exemplary parking brake system 1 shown in FIG. 1 is used to control at least one parking brake 101 of a vehicle 100 that is not otherwise shown, wherein two such parking brakes 101 can be seen in FIG. 1 purely by way of example. Control of the parking brakes 101 includes both the engaging and the releasing of the parking brakes 101. Thus, a parking brake function 10 (see FIG. 2) may in particular be the engaging of the parking brake 101, the releasing of the parking brake 101, and the like. To control the parking brakes 101 and thus to perform the parking brake function 10, the parking brake system 1 comprises a parking brake control unit 2 and an evaluation device 3. The evaluation device 3 can be configured as a microcontroller. The evaluation device 3 performs a corresponding parking brake function 10 (see FIG. 2) by way of the parking brake control unit 2 to control the respective parking brake 101. According to FIG. 1, the parking brake control unit 2 may comprise at least one application-specific integrated circuit 7 for performing the parking brake function 10. The application-specific integrated circuit 7 is subsequently also abbreviated as “ASIC” 7. As shown in FIG. 1, the parking brake control unit 2 may comprise two such ASICs 7. The respective ASIC 7 can be associated with such a parking brake 101. Control of the parking brake 101, and thus execution of the parking brake function 10, expediently requires corresponding activation or deactivation of the parking brake, which is also hereinafter generally referred to as “actuation” 11. The actuation 11 may be performed manually. It is also conceivable that the actuation 11 occurs automatically. The parking brake function 10 performed also depends on parameters 12 (see also FIGS. 2 and 3), which are also hereinafter referred to as “input parameters” 12. Input parameters 12 include, for example, an electrical voltage, an electrical current, a temperature of at least one of the parking brakes 101, and the slope, on which the vehicle 100 is located. The input parameters 12 and the actuation 11 are transferred or made available to the parking brake system 1, in particular to the evaluation device 3 (see FIG. 1).

FIG. 2 shows an operating mode 4 of the parking brake system 1, in which the parking brake system 1, in particular the evaluation device 3, functions in a fault-free manner. This operating mode 4 is also hereinafter referred to as “regular operation” 4.

As can be seen from looking at FIGS. 1 and 2 together, the evaluation device 3 receives the input parameters 12 during the regular operation 4. In the exemplary embodiments shown, the evaluation device 3 also receives the actuation 11. As explained above, in the exemplary embodiments shown, the evaluation device 3 performs the parking brake function 10 by way of the parking brake control unit 2, i.e., in particular by way of the ASICs 7, as a function of the input parameters 12 provided that there is also an actuation 11. The specific execution of the parking brake function 10 is thus dependent on the available input parameters 12. Thus, for different input parameters 12, there may be respectively adapted parking brake functions 12. These are also hereinafter referred to as being associated with one another. That is, a specific parking brake function 10 may be associated with a set of input parameters 12.

During the regular operation 4, the parking brake function 10 is also learned by way of machine learning 13. That is, by way of machine learning 13, the dependence of the parking brake function 10 on at least a part of the input parameters 12 is learned. The thereby learned function 14 is also hereinafter referred to as such, i.e. as a “learned function” 14. In order to learn the function, at least a part of the input parameters 12 as well as the respective associated parking brake function 10 are considered, as indicated in FIG. 2. The considered input parameters 12 are advantageously recorded. Preferably, the respective parking brake function 10 is made dependent on the associated, considered input parameters 12. This advantageously occurs by way of linear regression. For example, as a replacement parking brake function 15, a release duration for releasing the parking brake 101 may be learned. The thereby learned function 14 is transferred to and stored in the parking brake control unit 2, in particular the respective ASIC 7, as indicated in FIG. 2. This transfer and storage can take place repeatedly. The execution of machine learning can be carried out by way of the evaluation device 3 and/or by way of at least one of the at least one ASIC 7.

If a fault or failure of the evaluation device 3 occurs, the parking brake system 1 is operated in an operating mode 5 indicated by way of example in FIG. 3, which is also hereinafter referred to as a “replacement operation” 5. As can be seen in FIG. 3, during the replacement operation 5, instead of the evaluation device 3, the learned function 14 is used, which, as mentioned above, is stored in the parking brake control unit 2, in particular in the respective ASIC 7. That is to say, during the replacement operation, a parking brake function 15 is performed using the learned function 14 as a function of at least a part of the input parameters 12, in particular of the considered input parameters 12, wherein this parking brake function 15 is also hereinafter referred to as a “replacement parking brake function” 15. Thus, the fault or failure of the evaluation device 3 is compensated. The use of machine learning 13 during the regular operation 4 to generate and optimize the learned function 14 results in the replacement parking brake function 15 being similar to, in particular corresponding to, the parking brake function 10 carried out during the regular operation 4.

Execution of the method, in particular learning the learned function 14 by way of machine learning 13, is preferably carried out by way of a computer program product. The computer program product comprises instructions that, when executed by a computer, cause the computer to carry out the method.

The method is preferably performed by way of the parking brake system 1. For this purpose, as indicated in FIG. 1, the parking brake system 1 can comprise a correspondingly configured control device 6.

What is claimed is:

1. A method to compensate in the event of a fault or failure of an evaluation device of a parking brake system, wherein the parking brake system includes a parking brake control unit and the evaluation device, the method comprising:
receiving input parameters during normal operation with the evaluation device and, as a function of the input parameters, performing a parking brake function by way of the parking brake control unit;
during the normal operation, learning as a learned function by way of machine learning the parking brake function performed by the evaluation device; and
in the event of a fault or failure of the evaluation device, performing a replacement parking brake function to compensate by way of the learned function as a function of at least a part of the input parameters.

2. The method according to claim 1, wherein:
at least a part of the input parameters and the respective associated parking brake function are considered to learn the learned function such that the respective performed parking brake function is made dependent on the associated, considered input parameters, and
in the event of a fault or failure of the evaluation device, the replacement parking brake function is performed as a function of the at least one considered input parameter.

3. The method according to claim 2, wherein the considered input parameters are recorded and the respective associated parking brake function is evaluated such that the respective parking brake function is made dependent on the associated, considered input parameters.

4. The method according to claim 2, wherein the respective parking brake function is made dependent on the associated, considered input parameters by way of linear regression.

5. The method according to claim 1, wherein the learned function is learned at least in part by way of the evaluation device.

6. The method according to claim 1, wherein the learned function is learned at least in part by way of at least one ASIC of the parking brake control unit.

7. The method according to claim 1, wherein the learned function is stored, repeatedly, in the parking brake control unit in at least one of the at least one ASIC.

8. A computer program product comprising instructions which, when executed by a computer, cause the computer to execute the method according to claim 1.

9. A parking brake system, comprising:
a parking brake control unit;
an evaluation device configured to perform a parking brake function during normal operation by way of the parking brake control unit; and
a control device configured to perform the method according to claim 1.

10. The parking brake system according to claim 9, wherein:
the parking brake control unit comprises two ASICs, and
one of the two ASICs is associated with a parking brake.

11. The method according to claim 1, wherein the evaluation device is a microcontroller.
